(19) United States
(12) Patent Application Publication
(10) Pub. No.: US 2013/0326360 A1
(43) Pub. Date: Dec. 5, 2013

(54) ELECTRONIC DEVICE AND METHOD FOR SETTING OPERATING INTERFACE ACCORDING TO INFORMATION DOWNLOADED VIA NETWORK

(71) Applicant: WISTRON CORPORATION, New Taipei City (TW)

(72) Inventors: Ching-Yuan Chuang, New Taipei City (TW); Chin-Hua Chen, New Taipei City (TW); Wei-Chu Chen, New Taipei City (TW); Chien-Chi Shen, New Taipei City (TW); Chia-Chih Chen, New Taipei City (TW); Yu-Fang Chen, New Taipei City (TW); Hui-Ju Lin, New Taipei City (TW); Shiuan-De Chen, New Taipei City (TW); Hung-Yang Hsu, New Taipei City (TW)

(73) Assignee: WISTRON CORPORATION, New Taipei City (TW)

(21) Appl. No.: 13/783,380

(22) Filed: Mar. 3, 2013

(30) Foreign Application Priority Data
Jun. 5, 2012 (TW) 101120125

(51) Int. Cl. G06F 3/0484

(52) U.S. Cl. CPC G06F 3/0484
USPC 715/746

(57) ABSTRACT

An electronic device and method for setting an operating interface according to information downloaded via network are disclosed. The electronic device includes a network transmission module for downloading at least one operating interface reference message by network transmission, a display module for displaying the operating interface, and a control unit coupled to the network transmission module and the display module for controlling the display module to display the corresponding operating interface according to the at least one operating interface reference downloaded by the network transmission module. Such operating interface can meet requirements for the diversity and customization of electronic products and has personal characters.

### BACKGROUND OF THE INVENTION

1. Field of the Invention

The present invention relates to an electronic device and method for setting an operating interface according to information downloaded via network, and especially relates to an electronic device and method for setting a personal operating interface according to information downloaded via network.

2. Description of the Prior Art

In recent years, the popularity of smart phones and tablet computers increase rapidly. However, the user quantity therefor is getting more numerous. Most smart phones and tablet computers are produced by mass production. Their appearances are much similar. Their operating interfaces are almost the same. If changing the operating interface to another style is needed, it is performed mainly by use of a few of default scheme styles or pictures stored in the systems of the current products, leading to a limited variety. Moreover, it still needs users' manual operation for changing the background or background scheme. Therefore, how to design an operating interface which can meet requirements for the diversity and customization of electronic products and has personal characters is one of important tasks we work for the man-machine interface of present electronic devices.

### SUMMARY OF THE INVENTION

The present invention provides an electronic device and method for setting a personal operating interface according to information downloaded via network for solving above drawbacks.

According to the claimed invention, an electronic device for setting an operating interface according to information downloaded via network is disclosed. The electronic device a network transmission module for downloading at least one operating interface reference message by network transmission, a display module for displaying the operating interface, and a control unit coupled to the network transmission module and the display module for controlling the display module to display the operating interface according to the at least one operating interface reference message downloaded by the network transmission module.

According to the claimed invention, the electronic device further includes a storage module coupled to the control unit for storing a plurality of groups of operating interface setting data. The control unit selects one corresponding group from the groups of operating interface setting data according to the at least one operating interface reference message downloaded by the network transmission module and controls the display module to display the operating interface by the selected corresponding group of operating interface setting data.

According to the claimed invention, each group of operating interface setting data corresponds to a background scheme profile.

According to the claimed invention, the control unit determines a corresponding matching color or scheme setting according to the at least one operating interface reference message downloaded by the network transmission module and controls the display module to display the operating interface by the corresponding matching color or scheme setting.

According to the claimed invention, the network transmission module downloads the operating interface reference message with respect to a constellation lucky color message by network transmission. The control unit controls the display module to display the operating interface in a corresponding matching color or scheme according to the constellation lucky color message.

According to the claimed invention, the network transmission module downloads the operating interface reference message with respect to a weather message by network transmission. The control unit controls the display module to display the operating interface in a corresponding matching color or scheme setting according to the weather message.

According to the claimed invention, the electronic device further includes an input module for inputting a selection parameter. The control unit controls the network transmission module to selectively download one from a plurality of operating interface reference messages according to the selection parameter.

According to the claimed invention, the electronic device further includes an input module coupled to the control unit for inputting a selection parameter. The control unit selects one from the operating interface reference messages downloaded by the network transmission module according to the selection parameter and controls the display module to display the operating interface according to the selected operating interface reference message.

According to the claimed invention, the network transmission module periodically downloads the at least one operating interface reference message by network transmission.

According to the claimed invention, the network transmission module is enabled by manually setting to download the at least one operating interface reference message by network transmission.

According to the claimed invention, a method for setting an operating interface of an electronic device according to information downloaded via network is disclosed. The method includes: a network transmission module of the electronic device downloading at least one operating interface reference message by network transmission, and a control unit of the electronic device controlling a display module of the electronic device to display the operating interface according to the at least one operating interface reference message downloaded by the network transmission module.

The present invention is to set the display module to display the operating interface according to information downloaded via network. For example, the combination of matching color and the configuration of background scheme of the operating interface is set according to the constellation lucky color message or weather message, so as to show a color style of personal constellation, destiny and luck, or immediate weather, so that the electronic device can be treated as a personal special lucky accessory or a mood adjustment accessory. Therefore, such operating interface can meet requirements for the diversity and customization of electronic products and has personal characters.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block function diagram illustrating an electronic device of an embodiment according to the present invention.

FIG. 2 is a flow chart of a method for setting an operating interface of the electronic device in FIG. 1 according to at least one operating interface reference message according to a first embodiment of the present invention.

FIG. 3 is a schematic diagram illustrating the operating interface of the electronic device in an original state according to the present invention.

FIG. 4 and FIG. 5 are schematic diagrams illustrating the operating interface of the electronic device in different updated states according to the present invention.

FIG. 6 is a flow chart of a method for setting the operating interface according to the operating interface reference message according to a second embodiment of the present invention.

### DETAILED DESCRIPTION

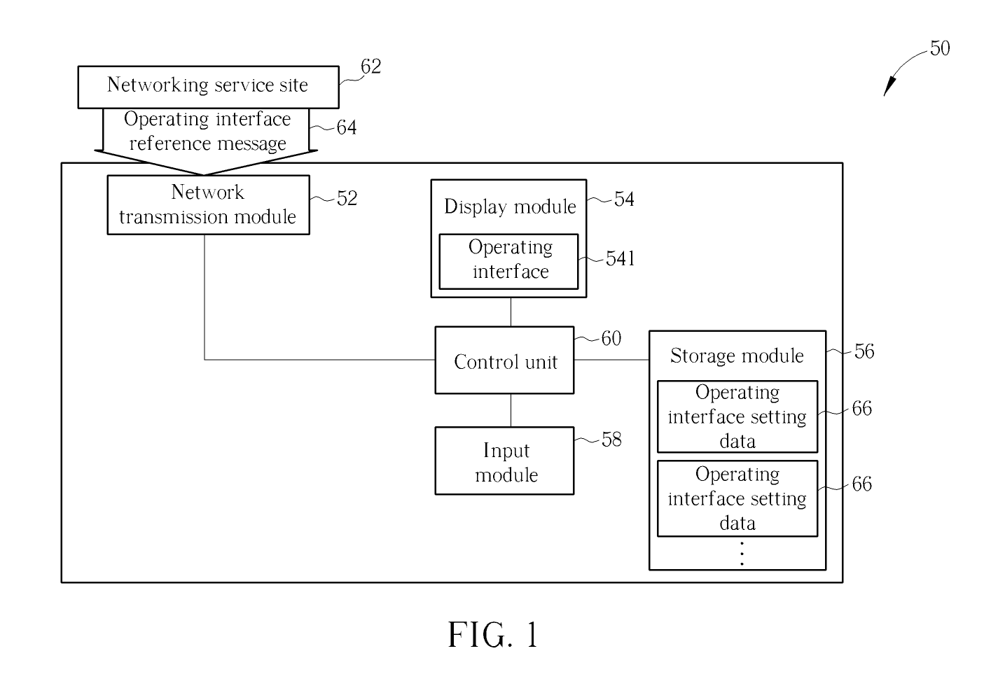

Please refer to FIG. 1, which is a block function diagram illustrating an electronic device 50 of an embodiment according to the present invention. The electronic device 50 can be a computer device or an electronic device, such as tablet computers, notebooks or smart phones. The electronic device 50 can set its operating interface according to information downloaded by network transmission. The electronic device 50 includes a network transmission module 52, a display module 54, a storage module 56, an input module 58, and a control unit 60. The network transmission module 52 is used for downloading at least one operating interface reference message 64 from a networking service site 62 by network transmission. Therein, the network transmission can be wired network transmission or wireless network transmission. The network transmission module 52 can periodically download the at least one operating interface reference message 64 by network transmission, or be enabled by manually setting to download the at least one operating interface reference message 64 by network transmission. The display module 54 is used for displaying an operating interface 541 regarded as a man-machine interface through which users can operate the electronic device 50. For example, the operating interface 541 can correspond to a background scheme setting. The storage module 56 is used for storing a plurality of groups of operating interface setting data 66. The operating interface setting data 66 can be a basis for setting the operating interface 541. For example, each group of operating interface setting data 66 corresponds to a background scheme profile. The input module 58 is used for users to input a selection parameter for selecting corresponding one from the operating interface reference message 64. The control unit 60 is coupled to the network transmission module 52, the display module 54, the storage module 56, and the input module 58 for controlling the operation of the above modules. It should be mentioned that the control unit 60 can be used for controlling the display module 54 to display the operating interface 541 according to the at least one operating interface reference message 64 downloaded by the network transmission module 52.

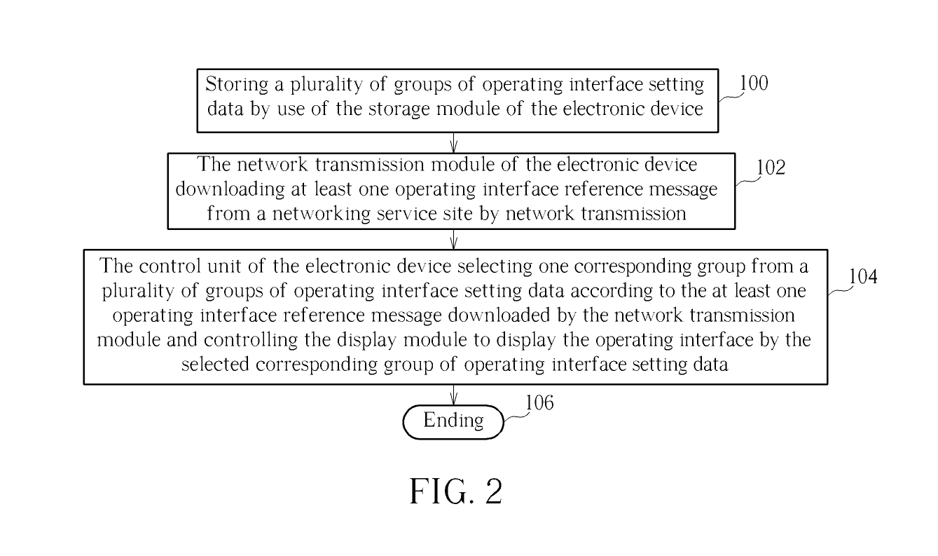

Please refer to FIG. 2, which is a flow chart of a method for setting the operating interface 541 according to the operating interface reference message 64 according to a first embodiment of the present invention. The method includes the following steps:

Step 100: storing a plurality of groups of operating interface setting data 66 by use of the storage module 56 of the electronic device 50,

Step 102: the network transmission module 52 of the electronic device 50 downloading at least one operating interface reference message 64 from a networking service site 62 by network transmission,

Step 104: the control unit 60 of the electronic device 50 selecting one corresponding group from a plurality of groups of operating interface setting data 66 according to the at least one operating interface reference message 64 downloaded by the network transmission module 52 and controlling the display module 54 to display the operating interface 541 by the selected corresponding group of operating interface setting data 66, and

Step 106: ending.

For further descriptions for the above steps, in the embodiment, the plurality of groups of operating interface setting data 66 can be stored in the storage module 56 of the electronic device 50 in advance; therein, each group of operating interface setting data 66 can correspond to a background scheme profile. The background scheme profile may include various interface items, such as desktop, picture, font, button, menu, scroll, sound and relational control functions. For example, functions for button can be stored in a function file, button.dll; background icons can be stored in a function file, image.dll. These depend on design requirements. Next, the network transmission module 52 of the electronic device 50 can download the at least one operating interface reference message 64 from the networking service site 62 by network transmission. For example, the network transmission module 52 can be set to periodically (e.g. every day, every week and so on) download the at least one operating interface reference message 64 from the networking service site 62 by network transmission, or be enabled by manually setting to download the at least one operating interface reference message 64 from the networking service site 62 by network transmission. Therein, the networking service site 62 can be a life website providing real-time information, such as everyday lucky colors and articles for every constellation, weather message and so on. Afterwards, the control unit 60 of the electronic device 50 can select one corresponding group from the plurality of groups of operating interface setting data 66 according to the at least one operating interface reference message 64 downloaded by the network transmission module 52 and controls the display module 54 to display the operating interface 541 by the selected corresponding group of operating interface setting data 66.

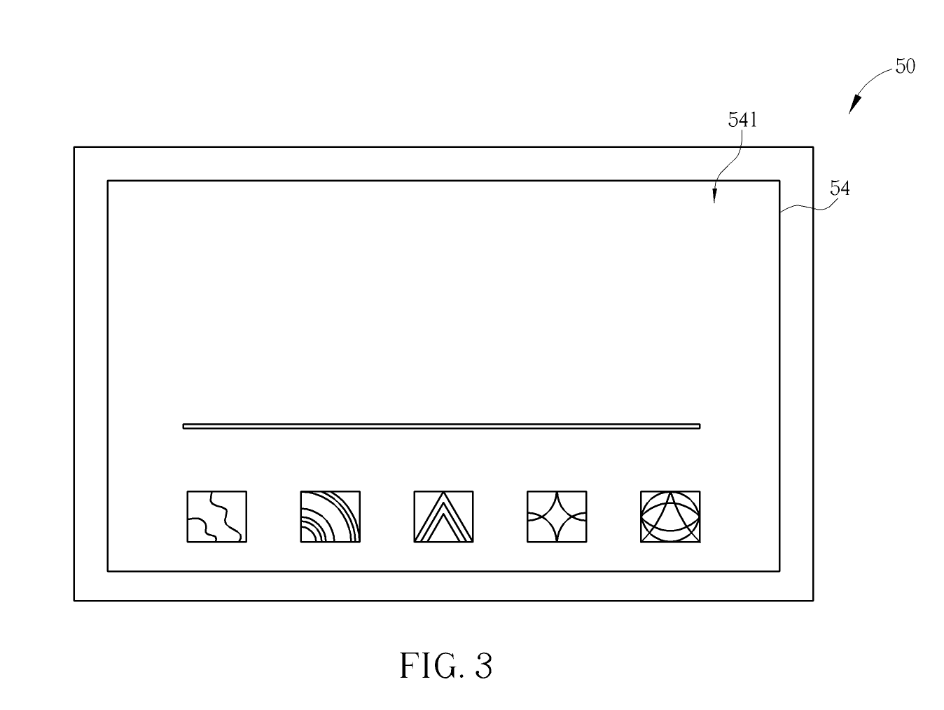

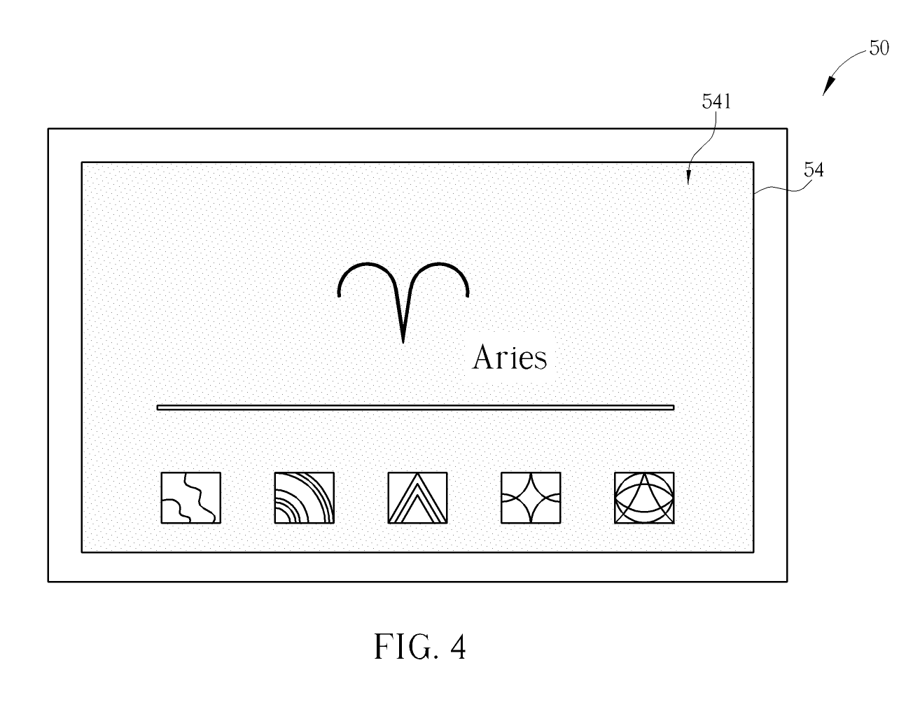

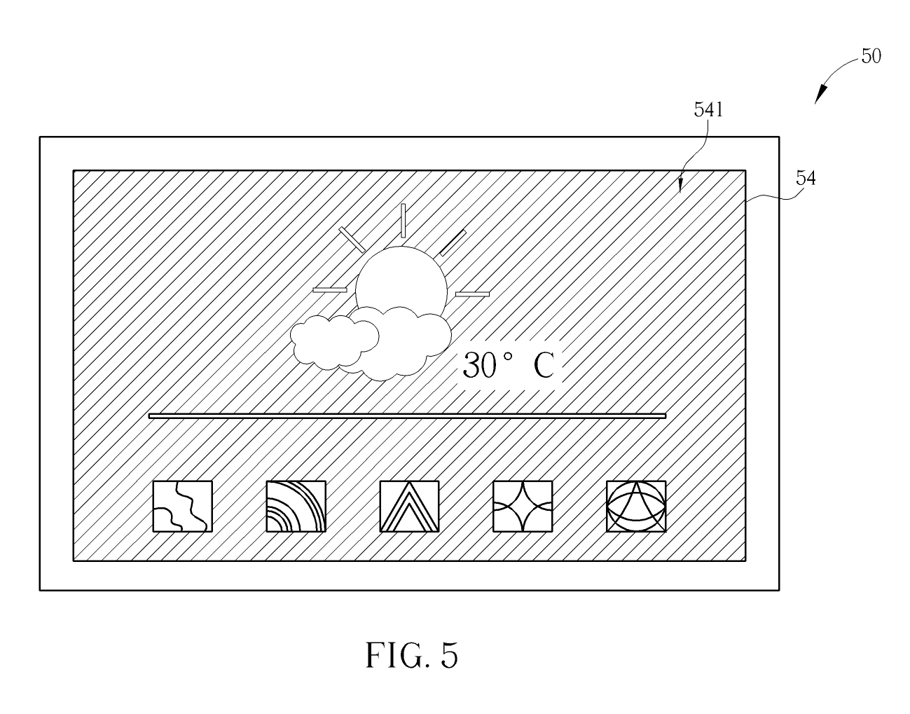

For example, please refer FIGS. 3 through 5. FIG. 3 is a schematic diagram illustrating the operating interface 541 of the electronic device 50 in an original state according to the present invention. FIG. 4 and FIG. 5 are schematic diagrams illustrating the operating interface 541 of the electronic device 50 in updated states according to the present invention. For example, if the network transmission module 52 downloads the operating interface reference message 64 with respect to a constellation lucky color message from the networking service site 62 by network transmission, the control unit 60 can be used for controlling the display module 54 to display the operating interface 541 from the original operating interface 541 shown by FIG. 3 to the updated operating interface 541 shown by FIG. 4 in the corresponding matching color or scheme according to the constellation lucky color message. For example, if the constellation lucky color of Aries the user belongs to in that day for the downloading is golden, the control unit 60 can select the operating interface setting data 66 corresponding to a golden matching color and control the display module 54 to display the operating interface 541 in the golden matching color, such as displaying the background, text, boarder and line in a golden color combination, so as to show a color style of personal constellation, destiny and luck so that the electronic device 50 can be treated as a personal special lucky accessory or a mood adjustment accessory. A man-machine interface which can meet requirements for the diversity and customization of electronic products and has personal characters is therefore obtained. For another example, it the network transmission module 52 downloads the operating interface reference message 64 with respect to a weather message from the networking service site 62 by network transmission, the control unit 60 can be used for controlling the display module 54 to the operating interface 541 from the original operating interface 541 shown by FIG. 3 to the updated operating interface 541 shown by FIG. 5 in a corresponding matching color or scheme setting according to the weather message. For example, the weather in that day for the downloading is a sunny and hot day, the control unit 60 can select the interface setting data 66 corresponding to a red matching color and control the display module 54 to display the operating interface 541 in the red matching color, such as displaying the background, text, boarder and line in a red color combination, so as to show a color style in conformity with the weather of that day; alternatively, the control unit 60 can select the interface setting data 66 corresponding to a cold matching color and control the display module 54 to display the operating interface 541 in the cold matching color, such as displaying the background, text, boarder and line in a cold color combination, so as to soothe an annoyed and impatient mood due to the baking-hot weather. Regarding the referring mechanism of determining a corresponding operating interface 541 according to the operating interface reference message 64, the present invention is not limited to the above embodiments. In practice, the referring mechanism depends on practical design requirements.

Furthermore, the input module 58 of the electronic device 50 according to the present invention can be used for inputting the selection parameter by users to be a basis for selecting corresponding one operating interface reference message 64. For example, a user can input the selection parameter by the input module 58 to determine downloading the operating interface reference message 64 from which networking service site 62 or to determine downloading one from a plurality of operating interface reference messages 64 provided on a specific networking service site 62. That is, the control unit 60 can control the network transmission module 52 to selectively download one from the plurality of operating interface reference messages 64 according to the selection parameter and control the display module 54 to display the operating interface 541 according to the selected operating interface reference message 64. For example, the user can select a desired constellation lucky color message or weather message to be a basis for displaying the corresponding operating interface 541. The control unit 60 can select one from the operating interface reference messages 64 downloaded by the network transmission module 52 according to the selection parameter and control the display module 54 to display the operating interface 541 according the selected operating interface reference message 64. For example, the network transmission module 52 is set to download the constellation lucky color message and the weather message. The control unit 60 selects the constellation lucky color message or the weather message to be a basis for displaying the operating interface 541. The above selecting mechanism is an optional configuration; besides, in practice, the choice for the selecting mechanism depends on practical design requirements.

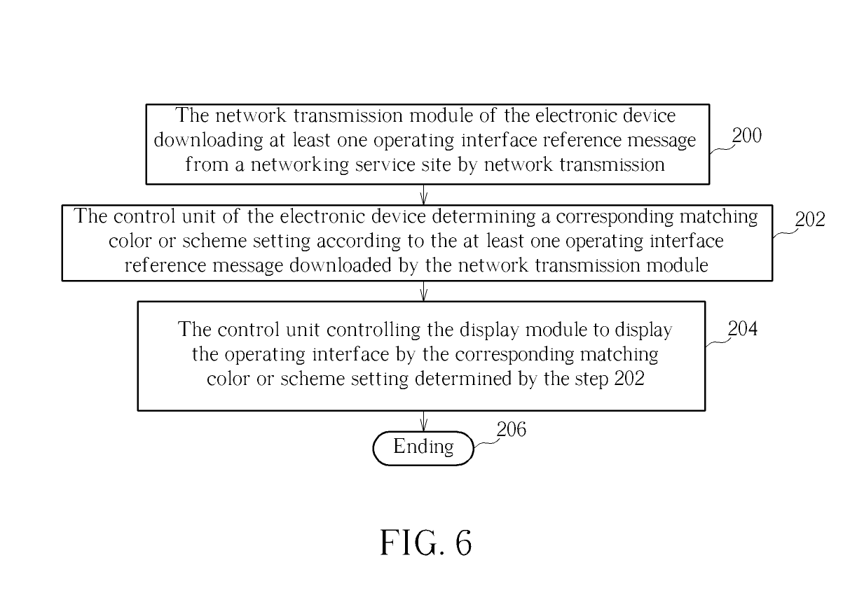

Furthermore, in another embodiment, the control unit 60 can be used for determining a corresponding matching color or scheme setting according to the at least one operating interface reference message 64 downloaded by the network transmission module 52 for controlling the display module 54 to display the operating interface 541 by the corresponding matching color or scheme setting. Please refer to FIG. 6, which is a flow chart of a method for setting the operating interface 541 according to the operating interface reference message 64 according to a second embodiment of the present invention. The method includes the following steps:

Step 200: the network transmission module 52 of the electronic device 50 downloading at least one operating interface reference message 64 from a networking service site 62 by network transmission,

Step 202: the control unit 60 of the electronic device 50 determining a corresponding matching color or scheme setting according to the at least one operating interface reference message 64 downloaded by the network transmission module 52,

Step 204: the control unit 60 controlling the display module 54 to display the operating interface 541 by the corresponding matching color or scheme setting determined by the step 202, and

Step 206: ending.

For further descriptions for the above steps, similar to the above embodiments, the network transmission module 52 of the electronic device 50 can download the at least one operating interface reference message 64 from the networking service site 62 by network transmission. For example, the network transmission module 52 can be set to periodically (e.g. every day, every week and so on) download the at least one operating interface reference message 64 from the networking service site 62 by network transmission, or be enabled by manually setting to download the at least one operating interface reference message 64 from the networking service site 62 by network transmission. Therein, the networking service site 62 can be a life website providing real-time information. In addition, in this embodiment, a user can use the input module 58 to input a selection parameter to be a basis for selecting corresponding one operating interface reference message 64. The difference between this embodiment and the above embodiments is that it is unnecessary to store a plurality of groups of operating interface setting data 66 in the storage module 56 of the electronic device 50 in advance; that is, the control unit 60 of the electronic device 50 can directly determine a corresponding matching color or scheme according to the at least one operating interface reference message 64 downloaded by the network transmission module 52. For example, the corresponding matching color can be automatically estimated according to some defined logic of matching color with referring to the downloaded constellation lucky color message or weather message for controlling the display module 54 to display the operating interface 541 by the corresponding matching color or scheme, such as displaying the background, text, boarder and line in the automatically-estimated matching color. Other function mechanisms of this embodiment are similar to those of the above embodiments and will not be repeated herein.

Compared with the prior art, the present invention is to set the display module to display the corresponding operating interface according to the operating interface reference message downloaded via network. For example, the combination of matching color and the configuration of background scheme of the operating interface is set according to the constellation lucky color message or weather message, so as to show a color style of personal constellation, destiny and luck, or immediate weather, so that the electronic device can be treated as a personal special lucky accessory or a mood adjustment accessory. A man-machine interface which can meet requirements for the diversity and customization of electronic products and has personal characters is therefore obtained.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device for setting an operating interface according to information downloaded via network, the electronic device comprising:
a network transmission module, for downloading at least one operating interface reference message by network transmission;
a display module, for displaying the operating interface; and
a control unit, coupled to the network transmission module and the display module for controlling the display module to display the operating interface according to the at least one operating interface reference message downloaded by the network transmission module.

2. The electronic device of claim 1, further comprising a storage module coupled to the control unit for storing a plurality of groups of operating interface setting data, the control unit selecting one corresponding group from the groups of operating interface setting data according to the at least one operating interface reference message downloaded by the network transmission module and controlling the display module to display the operating interface by the selected corresponding group of operating interface setting data.

3. The electronic device of claim 2, wherein each group of operating interface setting data corresponds to a background scheme profile.

4. The electronic device of claim 1, wherein the control unit determines a corresponding matching color or scheme setting according to the at least one operating interface reference message downloaded by the network transmission module and controls the display module to display the operating interface by the corresponding matching color or scheme setting.

5. The electronic device of claim 1, wherein the network transmission module downloads the operating interface reference message with respect to a constellation lucky color message by network transmission, and the control unit controls the display module to display the operating interface in a corresponding matching color or scheme according to the constellation lucky color message.

6. The electronic device of claim 1, wherein the network transmission module downloads the operating interface reference message with respect to a weather message by network transmission, and the control unit controls the display module to display the operating interface in a corresponding matching color or scheme setting according to the weather message.

7. The electronic device of claim 1, further comprising an input module for inputting a selection parameter, the control unit controlling the network transmission module to selectively download one from a plurality of operating interface reference messages according to the selection parameter.

8. The electronic device of claim 1, further comprising an input module coupled to the control unit for inputting a selection parameter, the control unit selecting one from the operating interface reference messages downloaded by the network transmission module according to the selection parameter and controlling the display module to display the operating interface according to the selected operating interface reference message.

9. The electronic device of claim 1, wherein the network transmission module periodically downloads the at least one operating interface reference message by network transmission.

10. The electronic device of claim 1, wherein the network transmission module is enabled by manually setting to download the at least one operating interface reference message by network transmission.

11. A method for setting an operating interface of an electronic device according to information downloaded via network, the method comprising the following steps:
a network transmission module of the electronic device downloading at least one operating interface reference message by network transmission; and
a control unit of the electronic device controlling a display module of the electronic device to display the operating interface according to the at least one operating interface reference message downloaded by the network transmission module.

12. The method of claim 11, further comprising storing a plurality of groups of operating interface setting data by use of a storage module of the electronic device, wherein the control unit controlling the display module of the electronic device to display the operating interface according to the at least one operating interface reference message downloaded by the network transmission module comprises the control unit selecting one corresponding group from a plurality of groups of operating interface setting data according to the at least one operating interface reference message downloaded by the network transmission module and controlling the display module to display the operating interface by the selected corresponding group of operating interface setting data.

13. The method of claim 12, wherein each group of operating interface setting data corresponds to a background scheme profile.

14. The method of claim 11, wherein the control unit controlling the display module of the electronic device to display the operating interface according to the at least one operating interface reference message downloaded by the network transmission module comprises the control unit determining a corresponding matching color or scheme setting according to the at least one operating interface reference message downloaded by the network transmission module and controlling the display module to display the operating interface by the corresponding matching color or scheme setting.

15. The method of claim 11, wherein the network transmission module downloading the at least one operating interface reference message by network transmission comprises the network transmission module downloading the operating interface reference message with respect to a constellation lucky color message by network transmission, and the control unit controlling the display module of the electronic device to display the operating interface according to the at least one operating interface reference message downloaded by the network transmission module comprises the control unit controlling the display module to display the operating interface in a corresponding matching color or scheme according to the constellation lucky color message.

16. The method of claim 11, wherein the network transmission module downloading the at least one operating interface reference message by network transmission comprises the network transmission module downloading the operating interface reference message with respect to a weather message by network transmission, and the control unit controlling the display module of the electronic device to display the operating interface according to the at least one operating interface reference message downloaded by the network transmission module comprises the control unit controlling the display module to display the operating interface in a corresponding matching color or scheme setting according to the weather message.

17. The method of claim 11, further comprising inputting a selection parameter by use of an input module of the electronic device, and the control unit controlling the network transmission module to selectively download one from a plurality of operating interface reference messages according to the selection parameter.

18. The method of claim 11, further comprising inputting a selection parameter by use of an input module of the electronic device, and the control unit selecting one from the operating interface reference messages downloaded by the network transmission module according to the selection parameter and controlling the display module to display the operating interface according to the selected operating interface reference message.

19. The method of claim 11, wherein the network transmission module downloading the at least one operating interface reference message by network transmission comprises the network transmission module periodically downloading the at least one operating interface reference message by network transmission.

20. The method of claim 11, wherein the network transmission module downloading the at least one operating interface reference message by network transmission comprises the network transmission module being enabled by manually setting to download the at least one operating interface reference message by network transmission.
